(19) United States
(12) Patent Application Publication
(10) Pub. No.: US 2011/0149909 A1
(43) Pub. Date: Jun. 23, 2011

(54) METHOD OF BINDING NETWORK-BASED FLOW THROUGH NOTIFICATION OF TERMINAL

(75) Inventors: Yoon Young AN, Daejeon (KR); Youn-Hee Han, Daejeon (KR); Ki Cheol Jeon, Daejeon (KR); Byungjun Ahn, Daejeon (KR)

(73) Assignees: Electronics and Telecommunications Research Institute, Daejeon (KR); Center for University-Industry Corporation, Cheonan (KR)

(21) Appl. No.: 12/949,490

(22) Filed: Nov. 18, 2010

(30) Foreign Application Priority Data
Dec. 21, 2009 (KR) 10-2009-0128421

(51) Int. Cl. H04W 8/00

(52) U.S. Cl. 370/331; 370/328

(57) ABSTRACT

A method of binding a network-based service flow is provided. The method binds a network-based service flow through notification of a terminal by allowing the terminal to notify a mobile access gateway (MAG) of binding information of a desired service flow at a specific moment by allowing intervention of the terminal, and allowing the MAG to again notify a local mobility anchor (LMA) of corresponding service flow binding information.

### CROSS-REFERENCE TO RELATED APPLICATION

This application claims priority to and the benefit of Korean Patent Application No. 10-2009-0128421 filed in the Korean Intellectual Property Office on Dec. 21, 2009, the entire contents of which are incorporated herein by reference.

### BACKGROUND OF THE INVENTION

(a) Field of the Invention

The present invention relates to a method of managing network-based mobility. Particularly, the present invention relates to a flow binding method for binding on a service flow basis of a terminal upon performing handover of the terminal having a plurality of different network interfaces.

(b) Description of the Related Art

Nowadays, in the Internet engineering task force (IETF), as PMIPv6 is set as a standard, a request for managing IP mobility by network-based mobility management is increased by mobile communication providers.

The PMIPv6 provides a mobile access gateway (MAG) function to an access router of a terminal and a local mobility anchor (LMA) function to a core network, and thus when the terminal is moved to an area that is managed by a new MAG, the PMIPv6 describes a procedure in which the corresponding MAG registers mobility binding information of the terminal to the LMA. That is, according to the PMIPv6, it is unnecessary for the terminal to perform any procedure for IP mobility management, and the terminal manages IP mobility through signaling between the MAG and the LMA only existing in a network.

As various kinds of networks are developed and are commercially available, a plurality of networks are mixed in the same area, and a terminal (hereinafter, a “multiple interface terminal”) having a plurality of network interfaces is provided such that a heterogeneous network (i.e., a mixed network) may selectively receive a service from a specific network.

In conventional PMIPv6, technology for supporting mobility when performing handover of a multiple interface terminal is suggested.

However, while a multiple interface terminal that performs handover based on the PMIPv6 receives a plurality of services through one network interface, the multiple interface terminal frequently performs handover, and in this case, the conventional PMIPv6 does not suggest an alternative proposal that moves a part of a plurality of service flows in a service state to another network interface of the multiple interface terminal.

Therefore, the following documents for solving such a problem are suggested.

1) First document: draft-hui-netext-service-flow-identifier-00 (service flow identifier in proxy mobile IPv6)

2) Second document: draft-xia-netext-flow-binding-00 (flow binding in proxy mobile IPv6)

3) Third document: draft-koodli-netext-flow-handover-00.txt (flow handover for proxy mobile IPv6)

The first document defines a format of a service flow identifier option for notifying the LMA of specific service flow information in the PMIPv6, and suggests that the service flow identifier option is included in proxy binding update (PBU) and proxy binding acknowledgement (PBA). In the first document, a time point at which the service flow identifier option is included in the PBU and is sent to the LMA is determined when the MAG receives data belonging to a new service flow from any interface of the terminal. That is, after the terminal is connected to a network through a new interface, when specific traffic is sent to the MAG through the interface, the MAG, having received the traffic analyzes the traffic, then makes a service flow identifier option, and sends the service flow identifier option together with the PBU when sending the PBU to the LMA.

However, the first document has a problem that service flow binding is requested only when data traffic of a new service flow, i.e., uplink traffic, is sent from the terminal to the MAG, and that service flow binding cannot be requested when traffic is sent from another corresponding node to a corresponding node, i.e., when downlink traffic is sent to the MAG. According to the first document, in a situation where uplink traffic is temporarily absent after handover, when downlink traffic arrives in the LMA, the traffic may arrive in an interface that is not presently intended by the terminal.

The second document reuses a flow identifier that is suggested in a draft-ietf-next-flow-binding-03.txt document for supporting a service flow binding service of MIPv6, which is an existing host-based mobility management protocol, without newly determining a format of a service flow identifier option. However, according to the second document, in order to cause service flow handover, a flow binding policy for a specific service of the terminal depends on a profile of the terminal or a provider's policy. That is, a binding method for a specific flow is stored in a database that manages various information of the terminal, and service flow binding is started based on the stored information.

Therefore, the second document has a problem that a user who actually uses a terminal starts service flow binding with reference to only previously stored static information regardless of a desired preference at that moment. For example, a previously stored profile describes that VolP service traffic should be exchanged through a WLAN interface, but a scenario in which the user should use a VolP service using a 3GPP interface at a specific moment for any reason cannot be supported.

The third document defines a flow handover request (FHRQ) and a flow handover reply (FHRP), which are separate signaling messages for service flow handover, and does not define a separate identifier for identifying a service flow, and uses a method of putting an IP address and a port number for identifying a flow as an option of the above two messages.

Therefore, in the third document, because a method of causing handover of the service flow still depends on a profile of the terminal or a provider's policy, as in the second document, the third document has the same problem that is described for the second document.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of binding a network-based service flow through notification of a terminal.

Also, the present invention has been made in an effort to further provide a method of binding a network-based service flow through notification of a terminal having advantages of allowing service flow binding in which an intention of the terminal is accurately reflected, as the terminal directly controls service flow binding.

An exemplary embodiment of the present invention provides a method of binding a network-based service flow that binds a service flow of a mobile node (MN) having a plurality of interfaces in order to connect to each of heterogeneous networks. The method includes: registering mobility binding information of the MN that is connected to a first mobile access gateway (MAG) of a first network using a first interface; generating an identifier of a first service flow according to a predetermined agreement between the first MAG and a local mobility anchor (LMA) when the first service flow is generated according to a first service request through the first interface of the MN; updating, by the first MAG, binding information of the first service flow in order to notify that a network that provides the first service is a first network by providing a first proxy binding update (PBU) including the first service flow identifier to the LMA; including, by the first MAG, the first service flow identifier in a first message that is provided to the MN and providing the first message to the MN; and updating, by the MN, routing information in order to notify that a network that provides the first service using the first service flow identifier that is grasped through the first message is the first network.

Another embodiment of the present invention provides a method of binding a network-based service flow that binds a service flow of an MN having a plurality of interfaces in order to connect to each of heterogeneous networks. The method includes: transmitting, by the MN, having received a first service through a first network, a first message including a first service flow identifier to a first MAG of a second network; updating, by the first MAG, binding information of the first service flow in order to notify that a network that provides the first service is the second network by providing a PBU including the first service flow identifier to the LMA; transmitting, by the first MAG, having received a response of the PBU, a second message including the first flow service identifier to the MN; and updating, by the MN, routing information in order to notify that a network that provides the first service using the first service flow identifier that is grasped through the second message is the second network.

Yet another embodiment of the present invention provides a method of binding a network-based service flow that binds a service flow of an MN having a plurality of interfaces in order to connect to each of heterogeneous networks. The method includes: updating, by the MN, having received a first service through a first network, routing information in order to notify that a network that provides the first service using the first service flow identifier is the first network according to a user's request for moving the first service to a second network; transmitting, by the MN, the first message including the first service flow identifier to a first MAG of the second network; updating, by the first MAG, binding information of the first service flow in order to notify that a network that provides the first service is the second network by providing a PBU including the first service flow identifier to an LMA; and notifying, by the first MAG, having received a response of the PBU, the MN of binding information update success of the first service flow.

### BRIEF DESCRIPTION OF THE DRAWINGS

FIG. 1 is a diagram illustrating heterogeneous protocol mixed networks for applying the present invention.

FIG. 2 is a data flowchart illustrating a method of binding a network-based service flow according to a first exemplary embodiment of the present invention.

FIG. 3 is a service flow state diagram before handover for additionally describing a method of binding a network-based service flow according to the first exemplary embodiment of the present invention that is described with reference to FIG. 2.

FIG. 4 is a service flow state diagram after handover for additionally describing a method of binding a network-based service flow according to the first exemplary embodiment of the present invention that is described with reference to FIG. 2.

FIG. 5 is a data flowchart illustrating a method of binding a network-based service flow according to a second exemplary embodiment of the present invention.

FIG. 6 is a service flow state diagram for additionally describing a method of binding a network-based service flow according to the second exemplary embodiment of the present invention that is described with reference to FIG. 5.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Now, a method of binding a network-based service flow through notification of an integrated terminal according to an exemplary embodiment of the present invention will be described in detail with reference to the drawings.

In the exemplary embodiment of the present invention, the method of binding a network-based service flow is performed, for example, in a proxy mobile Internet protocol version 6 (PMIPv6) domain, but is not restricted thereto.

Before the description, in the present invention, a method of binding a service flow between a mobile access gateway (MAG) and a local mobility anchor (LMA) while basically following a network-based service flow binding policy is used, as in an existing method that is submitted to an Internet engineering task force (IETF). In basic information that manages a service flow between the MAG and the LMA, an identifier for a service flow is used, as in a first document and a second document that are submitted to the IETF, but which type of service flow identifier is used and how to generate the identifier use a method to be standardized later in the IETF.

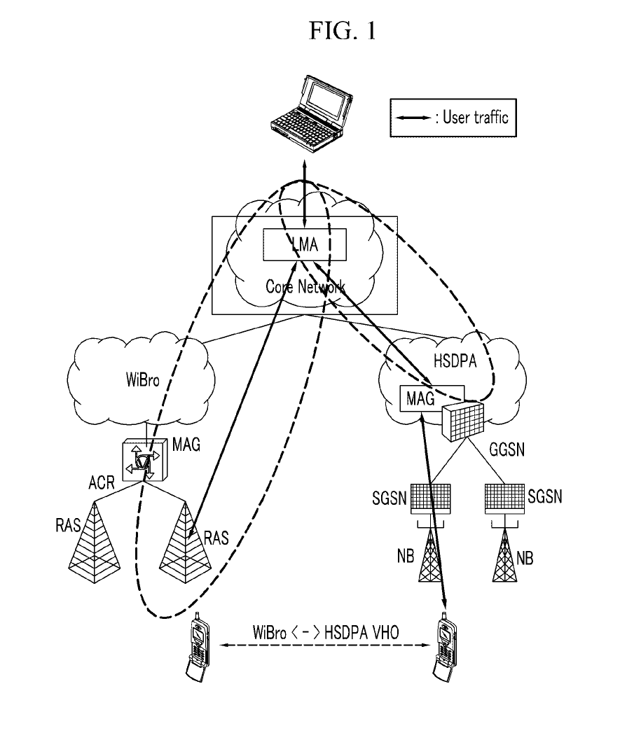

FIG. 1 is a diagram illustrating heterogeneous protocol mixed networks for applying the present invention.

As shown in FIG. 1, a heterogeneous protocol mixed network to which an exemplary embodiment of the present invention is applied is a network in which a high-speed downlink packet access (HSDPA) network, which is one of a WiBro network and a 3rd generation (3G) network is mixed. In this case, the WiBro network and the HSDPA network may be in an overlapped form, in an independent form, or in a partially overlapped form.

An ACR of the WiBro network and a gateway GPRS support node (GGSN) of the HSDPA network perform a mobile access gateway (MAG) function for providing IP mobility, and a device having a local mobility anchor (LMA) function is provided in a core network.

A mobile node (MN) is a multiple interface terminal, and includes a WiBro interface (not shown) for allowing communication to be performed through the WiBro network and an HSDPA interface (not shown) for allowing communication to be performed through the HSDPA network.

Such an MN may receive a service by connecting to the WiBro network through the WiBro interface, may receive a service by connecting to the HSDPA network through the HSDPA interface, or may receive a service from the WiBro network and the HSDPA network through the WiBro interface and the HDSPA interface, respectively.

When a service flow is generated according to a service request of the MN, the MAG and the LMA generate a service flow ID for a service flow that is generated by a predetermined agreement thereof.

In the exemplary embodiment of the present invention, the network and the MN share the generated service flow ID, and thus upon performing handover of the MN, the service flow ID is used for moving some or all of a service flow to an interface of the handover network.

Movement of the service flow binds a service flow ID between the MAG and the LMA and is synchronized with binding of the service flow ID and thus an interface for a corresponding service flow is changed even in the MN. Specifically, in the exemplary embodiment of the present invention, the

MAG requests binding of a service flow ID to the LMA and the LMA accepts a request for binding of the service flow ID, and thus binding of the service flow ID is performed, and the MAG notifies the MN of the generated service flow ID and the MN changes an interface, thereby synchronizing the change of the service flow interface.

In this case, a situation of causing binding of a service flow occurs based on a profile of the MN or a provider's policy.

Accordingly, when the MN receives the service flow ID from the MAG, the MN has a first function portion (not shown) that registers the service flow ID to a session management table to correspond to a corresponding interface.

The MN grasps a service flow using (i.e., registered) on an interface basis through a service flow ID in an application session management table, and includes a service flow transformer portion (not shown) that can map a specific service flow to another interface according to a user's request.

The service flow transformer portion can select that the user is to receive a service through which interface in a specific service flow according to the user's preference. For example, when the MN receives a first service through the WiBro interface and receives a second service through the 3G interface, the user can receive the first service through the 3G interface and the second service through the WiBro interface using the service flow transformer portion.

A service flow moving function between active interfaces of the service flow transformer portion is a function of dynamically moving some or all of the service flow as the user wants between activated interfaces so that the user may presently give and receive normal traffic.

When an interface corresponding to the service is changed, the service flow transformer portion matches and registers a service flow ID of a corresponding service that is registered to the session management table to the changed interface.

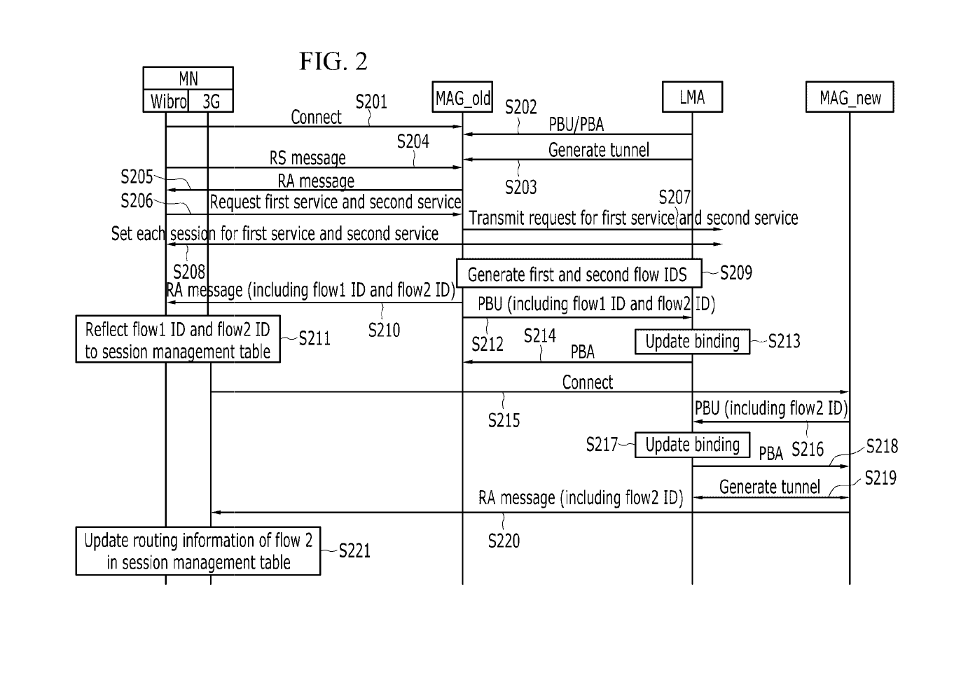

Hereinafter, a method of binding a network-based service flow according to the first exemplary embodiment of the present invention will be described with reference to FIGS. 2 to 4.

Before the description, in the first exemplary embodiment of the present invention, handover of the MN is performed from the WiBro network to the 3G network (i.e., a HSDPA network), and in this case, a service flow ID that is newly generated in the MAG is used to notify using a router advertisement (RA) message in the network (i.e., MAG).

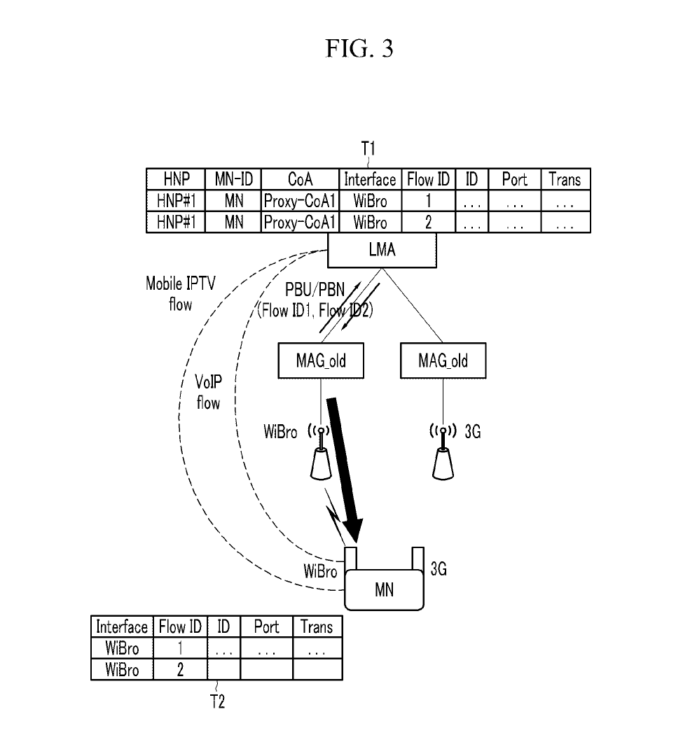

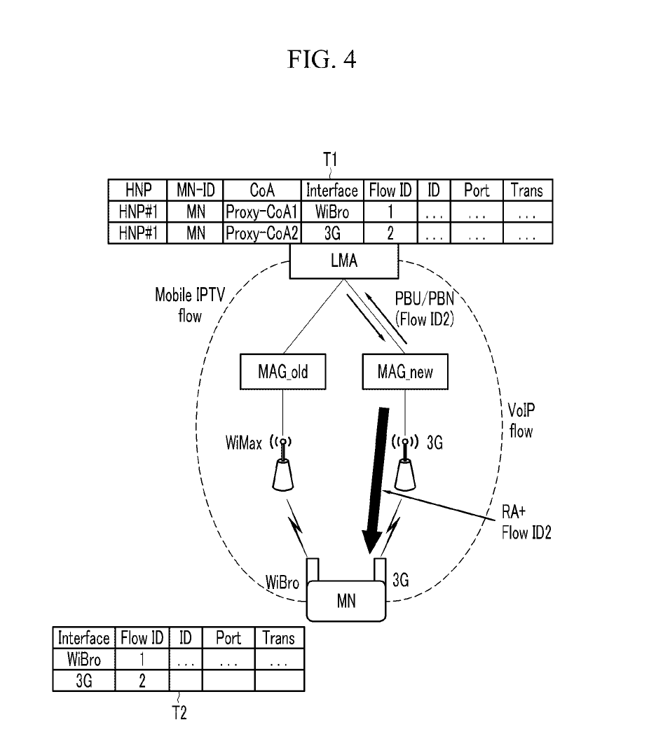

FIG. 2 is a data flowchart illustrating a method of binding a network-based service flow according to a first exemplary embodiment of the present invention, and FIG. 3 is a service flow state diagram before handover for additionally describing a method of binding a network-based service flow according to the first exemplary embodiment of the present invention that is described with reference to FIG. 2. FIG. 4 is a service flow state diagram after handover for additionally describing a method of binding a network-based service flow according to the first exemplary embodiment of the present invention that is described with reference to FIG. 2.

As shown in FIG. 2, when the MN is connected to an MAG (hereinafter, referred to as an “MAG_old”) of the WiBro network through the WiBro interface (S201), the MAG_old acquires an identifier and a profile of the MN, generates a terminal connection event trigger, and requests a proxy binding update (PBU) from the LMA.

The LMA grasps routing information (e.g., routing table and rule) by accepting a PBU request of the MAG_old, and sets a binding cache entry (BCE).

Hereinafter, the BCE is referred to as a service binding table T1. The service binding table T1 further includes general information for binding, i.e., information for managing a service flow together with routing information of the MN.

That is, the service binding table T1 includes a home network prefix (HNP), an MN-ID, which is an identifier of the MN, a care-of address (CoA), which is an address of the MAG old to which the MN is connected, and an interface representing a flow ID, which is an ID of a service flow in which the MN is using and a network in which a corresponding service flow is provided, as shown in FIGS. 3 and 4. The binding table T1 may further include an IP representing an IP address of a correspondent node (CN), a Port representing a service port, and a Trans representing a transmission protocol.

Thereafter, the LMA transmits proxy binding acknowledge (PBA) to the MAG_old as a response to the PBU (S202).

The MAG_old checks the PBA of the LMA, generates a bi-directional tunnel between the LMAS, and sets routing information (e.g., CoA, interface, IP, Flow ID, and Trans) corresponding to the MN (S203).

When the MN first connects to the WiBro network, the MN transmits a router solicitation (RS) message to the MAG_old (S204), and the MAG_old transmits a unicast type RA message as a response to the RS message to the MN, thereby notifying the MN of its existence (S205).

In this way, when the tunnel is generated, a subscriber performs a service that the subscriber wants through the MN. When the subscriber tries to perform communication while watching a television, the subscriber receives an IPTV service by requesting the IPTV service through the MN and requests a communication service, or receives a communication service by requesting the communication service and requests the IPTV service.

In the following description, for convenience of description, an IPTV service is referred to as a first service and a communication service (i.e., a VolP service) is referred to as a second service, and a service providing procedure for each of two services (i.e., the first service and the second service) should be sequentially described, but because the service providing procedures are the same, a service providing procedure will be described.

When the MN requests the first service and the second service by a user request (S206), the MAG_old transmits a service request message to each service server (not shown) that provides a corresponding service (S207).

Accordingly, a session for the services is set between the service server and the MN (S208), and a service flow between the MN H the MAG_old H the service server is formed through a predetermined session.

As the service flows are formed, IDS (fowl ID and flow2 ID) for first and second service flows, respectively, are generated between the MAG_old and the LMA (S209), and the MAG_old includes the generated service flow ID in an option field of the RA message and transmits the RA message to the MN (S210).

In this case, information that is included in an option field of the RA message that is transmitted from the MAG_old to the MN may include an IP address, a port number, and a transport protocol name of a correspondent node (CN) together with a service flow ID.

When the MN receives the service flow ID, the MN matches a service flow ID that is received in a stored session management table T2 to a corresponding interface and registers the service flow ID (S211).

In this case, the session management table T2 includes a flow ID, which is an ID of a using service flow and an interface representing an interface in charge of the corresponding service flow, as shown in FIGS. 3 and 4. The session management table T2 may further include an IP representing an IP address of a correspondent node (CN), an interface representing a network in which a corresponding service flow is provided, a Port representing a service port, and a Trans representing a transmission protocol.

When a session is set through the process S208, the MAG_old transmits the PBU (including a service flow ID) requesting binding update for the generated service flow ID to the LMA (S212).

Accordingly, the LMA updates (or generates) the service binding table T1 for the MN (S213), as shown in FIG. 3.

When binding update for a service flow is complete, the LMA transmits the PBA to the MAG_old (S214).

Here, the process S211 of transmitting an RA message including a service flow ID may be performed after the process S214.

Therefore, the MN receives an IPTV service, which is the first service and a communication service, which is the second service from the WiBro network through the WiBro interface. The MN and the LMA share the same information about a service flow through processes S210, S211, and S213.

In this state, when a situation in which the MN performs handover to the HSDPA network, which is a 3G network, occurs, a 3G interface of the MN requests handover by connecting to an MAG_new (S215).

The MAG_new, having received a handover connection of the MN, determines to provide a second service (communication service) of the MN through the 3G network by performing an operation according to management (follows a standard of IETT to be set later) for a service flow ID together with the LMA.

Accordingly, when requesting the proxy binding update (PBU) to the LMA, the MAG_new includes the second service flow ID in the PBU and transmits the PBU (S216).

Therefore, the LMA grasps routing information by accepting a PBU request of the MAG_new and updates binding, and updates service binding through the second service flow ID (flow2 ID) that is included in the PBU (S217).

Here, by updating service binding, matching of the second service flow ID (flow2 ID) is varied from the WiBro interface to the 3G interface in the service binding table T1, as shown in FIG. 4.

When binding update is complete, the LMA transmits the PBA to the MAG_new (S218), and the MAG_new checks the PBA of the LMA, generates a bi-directional tunnel between the LMAS, and sets routing information (e.g., CoA, Interface, IP, Flow ID, and Trans) corresponding to the MN (S219).

The MAG_new includes the second service flow ID in the RA message in order to notify a change of the second service flow, and transmits the RA message to the MN (S220). Therefore, the MN checks that the second service flow ID is included in the RA message that is received through the 3G interface, and thus updates routing information of the second service flow that changes matching of the second service flow ID that is registered in a session management table to the 3G interface (S221).

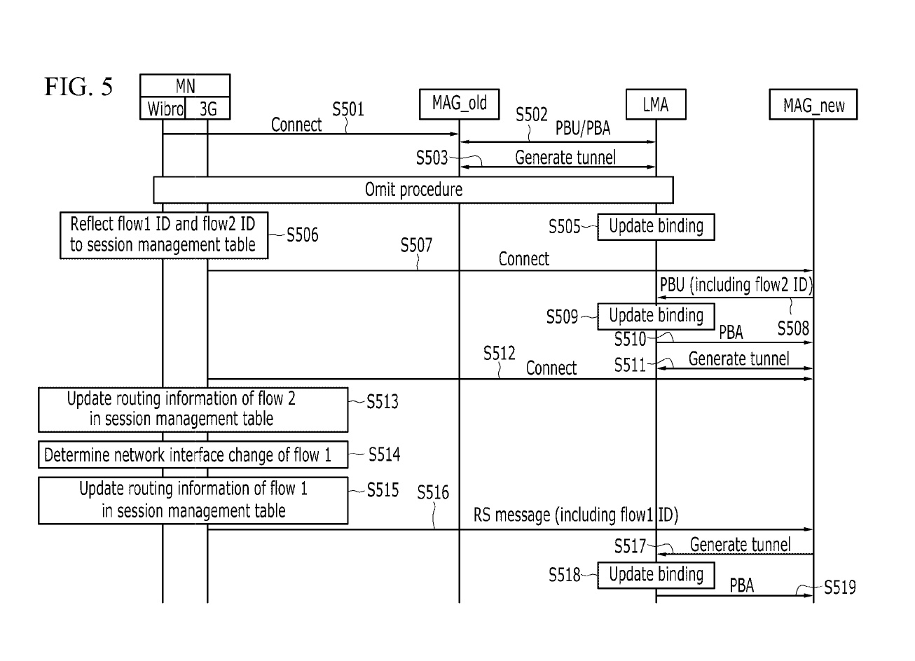

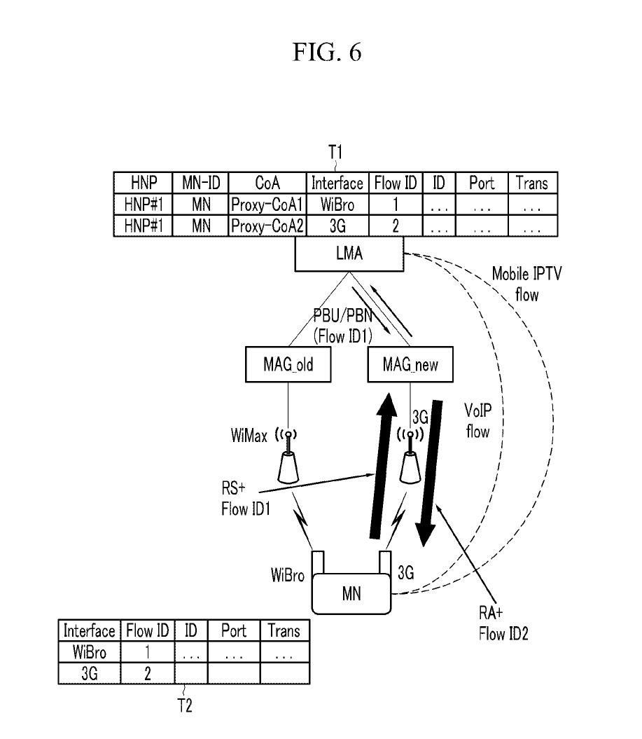

Hereinafter, a method of binding a network-based service flow according to a second exemplary embodiment of the present invention will be described with reference to FIGS. 5 and 6.

The second exemplary embodiment of the present invention describes a case of binding a corresponding service flow by synchronizing the network and the MN to correspond to a case where the user requests to receive a service through a specific service flow from a presently connected network through another heterogeneous network.

In the second exemplary embodiment of the present invention, a method of binding a service flow is applied in an MN state after service flow binding after handover that is described with reference to FIG. 4. However, a method of binding a service flow according to the second exemplary embodiment of the present invention can be applied before handover, and the application can be easily executed by a person of ordinary skill in the art through the following description and therefore a detailed description thereof will be omitted.

As shown in FIG. 3, the MN provides the first and second services through the WiBro interface, after performing handover, the second service is provided through the 3G interface, and the first service is provided through the WiBro interface (S501 to S513), as shown in FIG. 4.

In this state, the user instructs to move the first service receiving through the WiBro interface to the 3G network interface.

Accordingly, a service flow transformer portion of the MN determines an interface change event for the first service flow (S514).

The service flow transformer portion of the MN moves and maps the first service flow that is mapped to the WiBro interface to the 3G interface and inactivates the WiBro interface. Further, the service flow transformer portion of the MN changes an interface of routing information about the first service flow ID (flow1 ID) that is registered to the session management table to the 3G interface (S515).

Thereafter, the MN includes the first service flow ID (flow1 ID) in an option field of an RS message, which is a message that is set as a PMIPv6 standard and that transmits from the MN to the MAG and transmits the RS message to the MAG_new (i.e., the MAG of the 3G network), and requests binding of the first service flow (S516). When the MAG_new receives the RS message in which the first service flow ID (flow1 ID) is included, the MAG_new transmits the PBU in which the first service flow ID (flow1 ID) is included to the LMA (S517).

The LMA grasps the first service flow ID that is included in the PBU and accepts a PBU request of the MAG_new, thereby updating a service binding table through the first service flow ID (flow1 ID) that is included in the PBU (S518), as shown in FIG. 6.

In this case, by grasping routing information that is included in the PBU, the LMA determines whether CoA is equal to the previously stored CoA, and if CoA is equal to the previously stored CoA, the LMA updates service flow binding that allows an interface corresponding to the first service flow ID (flow1

ID) to be 3G, and if CoA is not equal to the previously stored CoA, the LMA updates binding according to handover. The present invention may not perform a comparison process of CoA by including a separate identifier that instructs service flow binding in the PBU.

When update of service flow binding is complete, the LMA transmits the PBA to the MAG_new (S519).

The MAG_new knows that binding for the first service flow is updated with the received PBA, sends an RA message including the first service flow ID (flow1 ID) to the MN, and notifies the MN whether update of service flow binding is succeed.

In the foregoing exemplary embodiment, it is described that a binding update process (S515) in a session management table according to an interface change for the first service flow is performed before binding update in the LMA, but it is not limited thereto. For example, in an exemplary embodiment of the present invention, when an RA message that notifies update of service flow binding is received from the MAG_new, the process S515 may be performed.

According to the present invention, the MN directly controls service flow binding in real time when a user wants, thereby performing service flow binding in which an intention of the MN is accurately reflected.

Further, in the present invention, when the MN is set to perform communication with a new interface for a specific service flow using a service flow moving function between active interfaces, although downlink traffic of a service flow that is transferred from a correspondent node (ON) to the MN first arrives in the LMA before uplink traffic of a corresponding service flow advancing from the MN to the network occurs, the MN can receive uplink traffic in the intended new interface.

Further, in the present invention, compatibility can be sustained at 100% based on a network-based service flow binding control method to be standardized in IETF.

Further, in the present invention, an existing message is used to the maximum without defining a new message between the MAG and the MN.

An exemplary embodiment of the present invention may be not only embodied through the above-described apparatus and method, but may also be embodied through a program that realizes a function corresponding to a configuration of exemplary embodiments of the present invention or a recording medium on which the program is recorded and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of binding a network-based service flow that binds a service flow of a mobile node (MN) having a plurality of interfaces in order to connect to each of heterogeneous networks, the method comprising:
registering mobility binding information of the MN that is connected to a first mobile access gateway (MAG) of a first network using a first interface;
generating an identifier of the first service flow according to a predetermined agreement between the first MAG and a local mobility anchor (LMA) when the first service flow is generated according to a first service request through the first interface of the MN;
updating, by the first MAG, binding information of the first service flow in order to notify that a network that provides the first service is the first network by providing a first proxy binding update (PBU) including the first service flow identifier to the LMA;
including, by the first MAG, the first service flow identifier in the first message that is provided to the MN and providing the first message to the MN; and
updating, by the MN, routing information in order to notify that a network that provides the first service using the first service flow identifier that is grasped through the first message is the first network.

2. The method of claim 1, further comprising, after the updating routing information,
updating, by a second MAG, mobility binding information of the MN that is connected to the second MAG of a second network using a second interface and binding information of the first service flow in order to notify that a network that provides the first service is a second network by transmitting a second PBU including the first service flow ID to the LMA;
transmitting, by the second MAG having received a response of the second PBU, a second message including the first flow service identifier to the MN; and
updating, by the MN, the routing information in order to notify that a network that provides the first service using the first service flow identifier that is grasped through the second message is the second network.

3. The method of claim 2, further comprising,
transmitting, by the MN, the second message including the first service flow identifier to the second MAG according to a user's request for moving the first service to the first network;
updating, by the second MAG, binding information of the first service flow in order to notify that a network that provides the first service is the first network by providing a third PBU including the first service flow identifier to the LMA;
transmitting, by the second MAG, having received a response of the third PBU, the first message including the first flow service identifier to the MN; and
updating, by the MN, routing information in order to notify that a network that provides the first service using the first service flow identifier that is grasped through the first message is the first network.

4. The method of claim 2, further comprising,
updating, by the MN, routing information in order to notify that a network that provides the first service using the first service flow identifier is the first network according to a user's request for moving the first service to the first network;
transmitting, by the MN, the second message including the first service flow identifier to the second MAG;
updating, by the second MAG, binding information of the first service flow in order to notify that a network that provides the first service is the first network by providing a third PBU including the first service flow identifier to the LMA; and
notifying, by the second MAG, having received a response of the third PBU, the MN of binding information update success of the first service flow.

5. The method of claim 3, wherein the binding information of the first service flow comprises the first service flow identifier, the care-of address (CoA) of the first MAG, and identification information of a network that provides the first service, and
the routing information comprises the first service flow identifier and identification information of a network that provides the first service.

6. The method of claim 5, wherein the first message is a router advertisement (RA) message, and the second message is a router solicitation (RS) message.

7. The method of claim 6. wherein the first service flow identifier is included in an option field of the RA message and an option field of the RS message.

8. A method of binding a network-based service flow that binds a service flow of an MN having a plurality of interfaces in order to connect to each of heterogeneous networks, the method comprising:
transmitting, by the MN, having received a first service through a first network, a first message including a first service flow identifier to a first MAG of a second network;
updating, by the first MAG, binding information of the first service flow in order to notify that a network that provides the first service is the second network by providing a PBU including the first service flow identifier to the LMA;
transmitting, by the first MAG, having received a response of the PBU, a second message including the first flow service identifier to the MN; and
updating, by the MN, routing information in order to notify that a network that provides the first service using the first service flow identifier that is grasped through the second message is the second network.

9. The method of claim 8, wherein the binding information of the first service flow comprises the first service flow identifier, the CoA of the first MAG, and identification information of a network that provides the first service, and
the routing information comprises the first service flow identifier and identification information of a network that provides the first service.

10. The method of claim 9, wherein the first message is an RS message, and the second message is an RA message.

11. The method of claim 10, wherein the first service flow identifier is included in an option field of the RA message and an option field of the RS message.

12. A method of binding a network-based service flow that binds a service flow of an MN having a plurality of interfaces in order to connect to each of heterogeneous networks, the method comprising:
updating, by the MN, having received a first service through a first network, routing information in order to notify that a network that provides the first service using the first service flow identifier is the first network according to a user's request for moving the first service to a second network;
transmitting, by the MN, the first message including the first service flow identifier to a first MAG of the second network;
updating, by the first MAG, binding information of the first service flow in order to notify that a network that provides the first service is the second network by providing a PBU including the first service flow identifier to the LMA; and
notifying, by the first MAG, having received a response of the PBU, the MN of binding information update success of the first service flow.

13. The method of claim 12, wherein the binding information of the first service flow comprises the first service flow identifier, the CoA of the first MAG, and identification information of a network that provides the first service, and
the routing information comprises the first service flow identifier and identification information of a network that provides the first service.

14. The method of claim 13, wherein the first message is an RS message, and the second message is an RA message.

15. The method of claim 14, wherein the first service flow identifier is included in an option field of the RA message and an option field of the RS message.
